(19) United States
(12) Patent Application Publication
(10) Pub. No.: US 2012/0185380 A1
(43) Pub. Date: Jul. 19, 2012

(54) SYSTEM AND METHOD OF RESUME INFORMATION VERIFICATION AND CERTIFICATION

(76) Inventor: Christopher Won, Reston, VA (US)

(21) Appl. No.: 13/182,404

(22) Filed: Jul. 13, 2011

Related U.S. Application Data
(60) Provisional application No. 61/363,675, filed on Jul. 13, 2010.

(51) Int. Cl. G06Q 10/06; G06Q 40/00

(52) U.S. Cl. 705/39; 705/321

(57) ABSTRACT

A resume information verification and certification system is implemented on a website. A user creates a resume using the website interface and includes information regarding work history. For each position, the user can also include information regarding a contact at the organization where the user worked who can verify the work history details. The website system automatically verifies that the contact information provided belongs to a contact at the organization by comparing the email address domain with the organization's domain. The system then transmits the information to the contact in an email, along with an explanation of the site and a request for the contact to verify the work history information provided. The contact confirms or denies the information. The system notifies the user of the confirmation or denial and includes this in the user's resume on the website. Employers subscribe to search and access user resumes with verified information.

This application claims the benefit of provisional patent application No. 61363675, filed Jul. 13, 2010, which is hereby incorporated by reference in its entirety.

### BACKGROUND

The present invention relates to verification and certification of resume information.

Needs exist for improved systems and methods for verifying and certifying resume information.

### SUMMARY

It is to be understood that both the following summary and the detailed description are exemplary and explanatory and are intended to provide further explanation of the invention as claimed. Neither the summary nor the description that follows in intended to define or limit the scope of the invention to the particular features mentioned in the summary or in the description. Rather, the scope of the invention is defined by the appended claims.

In certain embodiments, the disclosed embodiments may include one or more of the features described herein.

A resume information verification and certification system is implemented on a website. A user creates a resume using the website interface and includes information regarding work history. For each position, the user can also include information regarding a contact at the organization where the user worked who can verify the work history details. The website system verifies that the e-mail address is a corporate email address, as opposed to a free web-based e-mail service, or that the contact information provided belongs to a contact at the organization by comparing the email address domain with the organization's domain, or both. The system then transmits the information to the contact in an email, along with an explanation of the site and a request for the contact to verify the work history information provided. The contact confirms or denies the information and transmits that back to the website system. The system then notifies the user of the confirmation or denial and includes this information alongside the information in the user's resume on the website. Employers subscribe to the system to be able to access user resumes with verified information used to apply for a job via the resume's unique URL. In some embodiments, subscribing employers are also able to search through and access resumes without knowing the unique URLs.

These and further and other objects and features of the invention are apparent in the disclosure, which includes the above and ongoing written specification, with the drawings.

### BRIEF DESCRIPTION OF THE DRAWINGS

The accompanying drawings, which are incorporated herein and form a part of the specification, illustrate exemplary embodiments and, together with the description, further serve to enable a person skilled in the pertinent art to make and use these embodiments and others that will be apparent to those skilled in the art. The invention will be more particularly described in conjunction with the following drawings wherein:

FIG. 1 is a diagram of a high level workflow of a resume verification process.

FIG. 2 is a block diagram illustrating an exemplary computing environment according to one embodiment of the present invention.

FIG. 3 shows a webpage according to one embodiment of the present invention.

FIG. 4 is a diagram illustrating use of a resume verification website.

FIG. 5 is a comparison of an ordinary resume with a verified resume.

### DETAILED DESCRIPTION

A system and method of resume information verification and certification will now be disclosed in terms of various exemplary embodiments. This specification discloses one or more embodiments that incorporate features of the invention. The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described. It will of course be appreciated that in the development of any such actual embodiment, numerous implementation-specific decisions may be made to achieve the developers' specific goals, such as compliance with system-related and business-related constraints, which may vary from one implementation to another. Moreover, it will be appreciated that such a development effort might be complex and time-consuming, but may nevertheless be a routine undertaking for those of ordinary skill in the art having the benefit of this disclosure.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail.

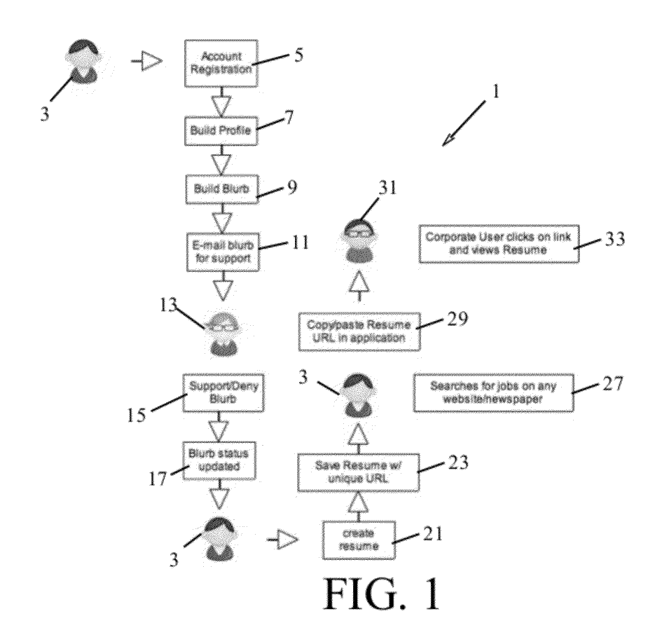

One embodiment of the invention is implemented as a program product for use with a computer system such as, for example, the computing environment 100 shown in FIG. 1 and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive, solid state storage devices); and (iii) information conveyed to a computer by a communications medium, such as through a computer or telephone network, including wireless communications.

The latter embodiment specifically includes information downloaded from the Internet and/or other networks. Such signal-bearing media, when carrying computer-readable instructions that direct the functions of the present invention, represent embodiments of the present invention. In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices.

In addition, various programs described hereinafter may be identified based upon the application for which they are implemented in one or more specific embodiments of the invention. However, it should be appreciated that any particular program nomenclature that follows is used merely for convenience, and thus the invention should not be limited to use solely in any specific application identified and/or implied by such nomenclature. In this regard, references to particular definitional languages, such as HTML and XML, are illustrative in nature and do not serve to limit the claims. It is broadly contemplated that the invention is applicable regardless of the particular schema and/or language used to define network resource content.

A website service checks resume facts by contacting employees or members of an employer or other organization listed.

In specific embodiments, job descriptions are automatically sent for verification by company employees who are themselves automatically verified by leveraging corporate email addresses. Other resume information is verified in a similar manner by leveraging organizational email addresses. Some indication is then provided with the resume, allowing the recipient of the resume to identify verified information and learn more about the verification. More detailed verification, including comment by the verifying parties, is possible, as are various levels of verification with higher or lower reliability, depending on resume recipients' desires.

In some embodiments, there is an online service where job applicants create their resumes online and get them vouched for by colleagues or supervisors via e-mail. After creating their own account, job applicants start creating their work history “blurbs”. Each blurb contains the name of the company, title, dates of employment and a description of their duties.

Once a blurb is scripted, a drop down field lists “colleague”, “supervisor”, “educator” and “other”. Once selected, a name field becomes available, with another field for e-mail address. In some embodiments other fields exist, such as for the person's job title. In one embodiment each blurb has three fields associated with it: Relationship, Name and E-mail address. The applicant now has the option to e-mail this specific blurb to the identified individual. The website does a check to make sure the e-mail address listed is not a free e-mail account (ex: yahoo, gmail, hotmail, aol, etc.) and sends an e-mail.

The email describes to the recipient what this service is and asks the recipient to support the blurb's accuracy. The e-mail has a button that offers three options: “support” and “deny” and “ignore”. Once a decision is input, an e-mail is sent to the job applicant notifying the job applicant that their blurb has been either confirmed or rejected. Once confirmed, this blurb can be used to build resumes, which can then be sent off to potential employers as an official ResumeSight resume.

Features for applicants include:

### Multiple Blurbs

Different variations of same blurb
Option to select different blurbs for different versions of resumes
Resumes contain blurbs, which can be stored and edited anytime

In one embodiment, employers sign up for the service for a per-user periodic subscription fee—e.g. one account, per user, per month. This fee grants the employers access to resumes submitted by applicants using the service. Employer features include:

Flat monthly rate per company user

Easy deactivation and reactivation for a period of 30 days

Custom templates available for additional fee

In some embodiments, a resume verification website is hosted on an Internet server. The website allows a user to input information relating to an organization and an email address for a contact at the organization. In some embodiments, this information is input as part of a resume creation or uploading process, and pertains to resume information. In some embodiment, the information pertains to the user's work history at the organization. In some embodiments, the information pertains to the user in some other way, for example to the user's schooling or training at the organization.

The website automatically verifies that the email address is associated with the organization, for example by comparing the email address domain with a database of organizational domains, or by comparing the email address domain with an organizational domain found on the Internet. Alternatively, the email address may be verified by requesting verification from the organization electronically, by email, text message, etc., or over the phone, in person, by mail, etc. Organizational website domains are generally easy to determine and provide an ideal means for automatically verifying the identity of the contact provided. In some embodiments the email address is checked to see if it is a free e-mail account.

If the email address cannot be verified, in some embodiments no further steps are taken and the user is notified of the failure. In other embodiments, the information verification process continues, but in some such embodiments the user or a subsequent viewer of the information are made aware of the failure of verification. In embodiments where multiple steps or levels of email authentication are performed, successful email authentication to a certain level allows information authentication to continue, and the level of successful email authentication is made known.

After email authentication, the information relating to the organization is transmitted to the contact, for example by email, for support. In an embodiment with email transmission, the server transmits an email containing the information or a link to a website containing the information to the contact, or both. The email or website provides an interface through which the contact can confirm or deny the information and transmit that confirmation or denial to the server. In some embodiments, the email or website indicates a way for the contact to transmit confirmation or denial other than through a provided electronic interface, for example by phone or mail.

The server receives the transmitted confirmation or denial and notifies the user of the result. If verification of the information was successful, this verification is indicated in some way when viewing the information, for example with a symbol like a check mark near the information. In some embodiments, information is provided about how the information was verified. In some embodiments, additional methods of verification are used to add certainty and in some embodiments the verification indication includes information as to which verification steps were successfully taken.

In an embodiment where the information is a user's work history with an organization, the information is part of a user resume stored in a database on the server. Employers (aka. Corporate Users) subscribe to the website and have a separate portal from users, through which they can search the stored resumes for prospective employees.

FIG. 1 is a diagram of a high level workflow of a resume verification process 1. A user 3 registers an account 5 and builds a profile 7, builds a blurb 9, and emails the blurb 11 to a contact for support. Contact 13 supports or denies the blurb 15, after which the blurb status is updated 17 to indicate the support or denial for the user 3 to see. The user 3 creates a resume 21 including the blurb with support or denial and saves the resume 23 with a unique URL. The user 3 searches for jobs 27, for example in the newspaper or on a jobs website, and places the resume URL in a job application 29. Corporate user 31 clicks on the link in the application and views the resume 33.

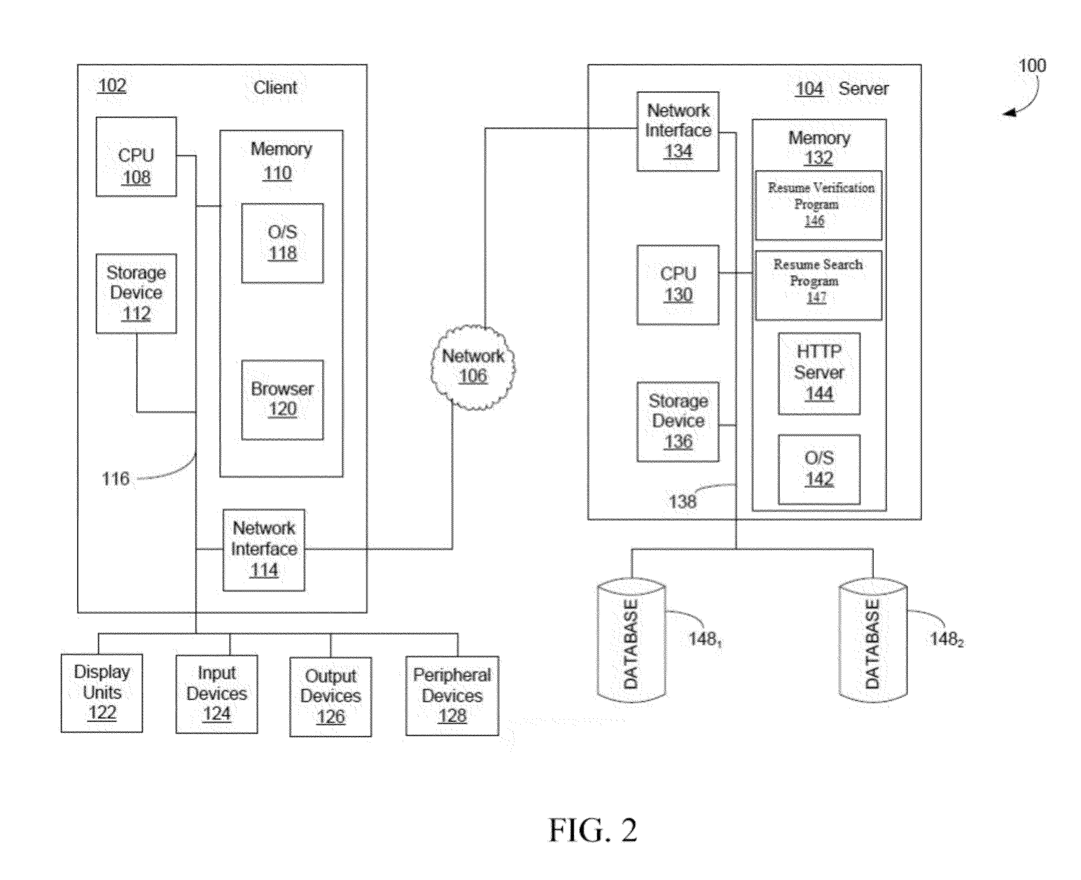

Turning now to FIG. 2, a block diagram illustrating an exemplary computing environment 100, in accordance with an embodiment of the present invention, is shown. In general, the computing environment 100 includes a client (e.g., a user's) computer 102, and a server computer 104. The client computer 102 and the server computer 104 may be components of the same computer system or may be connected via a network 106, such as the Internet.

As shown, the client computer 102 includes a central processing unit (CPU) 108 connected to a memory 110, a storage device 112, and a network interface 114 via a bus 116. The CPU 108 is included to be representative of a single CPU, multiple CPUs, a single CPU having multiple processing cores, and the like. The storage device 112 stores application programs and data for use by the client computer 102. Examples of the storage device 112 include one or more hard-disk drives, flash memory devices, optical media and the like. The client computer 102 may be connected to the data communications network 106 (e.g., a local area network, which itself may be connected to other networks such as the internet) using the network interface 114. The memory 110 can be one or a combination of memory devices, including random access memory, nonvolatile or backup memory (e.g., programmable or flash memories, read-only memories, etc.). Illustratively, the memory 110 of client computer 102 stores an operating system 118 used to manage hardware and software executing on the client computer 102. As shown, memory 110 also includes a browser program 120 which, when executed by CPU 108, provides support for navigating between various servers and locating network addresses at one or more of servers (e.g., server computer 104).

The client computer 102 may be connected to one or more display units 122, input devices 124, output devices 126 and peripheral devices 128. The display units 122 may be internal or external monitors, television screens, handheld device displays, and the like. The input devices 124 may be any one of a keyboard, mouse, track-ball, stylus, mouse pad, mouse button, joystick, scanner or the like. The output devices 126 may be any one of a monitor, printer, plotter, copier or other output device. The peripheral devices 128 may be any other device which can be coupled to a computer: a CD/DVD drive capable of reading and/or writing to physical digital media, a USB device, Zip Drive, external floppy drive, external hard drive, phone and/or broadband modem, router/gateway, access point and/or the like.

Similar to the client computer 102, the server computer 104 may include a CPU 130, a memory 132, a network interface device 134, and a storage device 136, coupled via a bus 138. The memory 132 may be a random access memory sufficiently large to hold the necessary programming and data structures that are located on the server computer 104. As shown, the memory 132 stores an operating system 140 used to manage server hardware and software executing on the server computer 102.

Illustratively, the memory 132 also includes a hypertext transfer protocol (http) server 144 configured to service requests from the client computer 102. For example, the http server 144 may respond to requests for access to electronic resources (e.g., HTML documents, network information, and the like) residing on the server computer 104. However, one of ordinary skill in the art will recognize that the http server 144 is merely illustrative and embodiments of the invention may be adapted to support both known and unknown protocols.

The programming and data structures of the http server 144 may be accessed and executed by the CPU 130 as needed during operation. The server computer 104 may connect to the network 106 using the network interface device 134 (e.g., an analog modem, a wired network card, or a wireless network device).

In one embodiment, users may interact with the server computer 104 using a graphical user interface (GUI). In a particular embodiment, GUI content may comprise HTML documents (i.e., web pages) rendered on the display unit 122 coupled with the client computer 102 using the browser 120. In one embodiment, the web pages may include pages that allow a user to create a resume and verify resume information and for an employer to access verified resumes.

The memory 132 may further include a resume verification program 146. The resume verification program 146 may comprise a software application configured to provide the ability (e.g., via the GUI) to upload resume information, create a resume, verify resume information, and make a resume available for employer search. Accordingly, the server computer 104 may be coupled to a plurality of databases 148₁, 148₂ which may include a relational database 148₁ that is queried using an SQL query, or an XML database 148₂ queried using an XML query. The invention, however, is not limited to any particular physical database storage mechanism and may readily be extended to operate on other such mechanisms, whether currently known or unknown. While the databases 148₁, 148₂ are illustrated as being external to the server system, it is noted that the databases 148₁, 148₂ may exist on a local storage device (e.g., storage device 136) of the server computer 104, or may be accessed over the network 106.

The memory 132 may also include a resume search program 147. The resume search program 147 may comprise a software application configured to provide the ability (e.g., via the GUI) to create an employer account, provide payment information, and search through verified resumes.

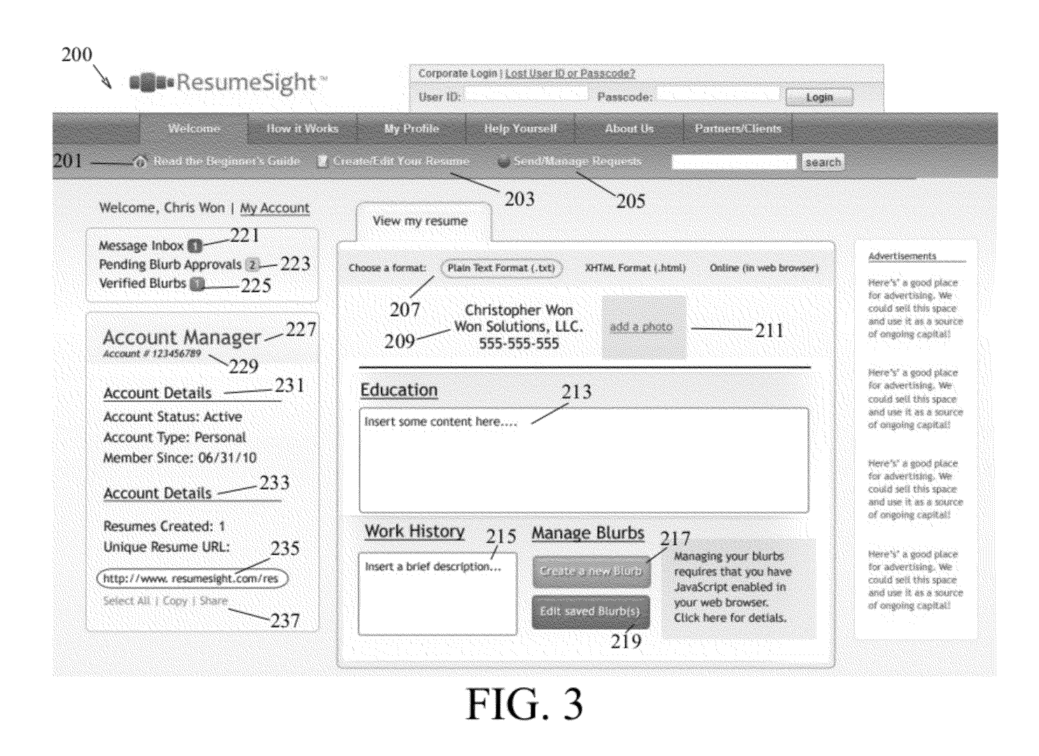

FIG. 3 shows a webpage 200 that forms a part of one embodiment of the invention. On this webpage, top links 201, 203, 205 enable a user to go straight to a page for reading a beginner's guide 201, create/edit a resume 203, or send/manage requests 205. In the center of the page resume information is displayed in plain text format, XHTML format, or online as set by format selection 207. User name, company and phone information 209 is listed next to a photo space 211. Below that is a field for education 213, work history 215, and Create a new Blurb button 217 and Edit save Blurb(s) button 219. A user selects the Create a new Blurb button 217 to enter some information about the user's work history for verification by an employee with the relevant organization.

To the left a user can see at a glance the number of messages 221, for example from prospective employers or from someone requested to verify a blurb, pending blurb approvals 223, and verified blurbs 225 that have been verified. The user's current or desired position 227 and a unique account #229 are displayed, as well as account details 231 such as whether the account is active and accepting employer messages, the account type (business/personal) and membership date. Additional account details 233 include the number of resumes created and a unique resume URL 235 which an employer or other person can enter to go directly to the user's resume. Links 237 allow the URL to be selected, copied to the user's clipboard, or shared by social media or email.

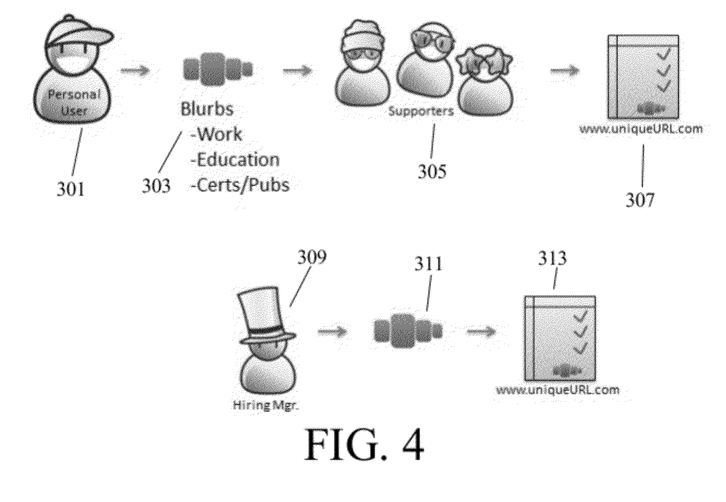

FIG. 4 illustrates use of an embodiment of a resume verification system. A personal user 301 registers at the resume verification website and uploads blurbs 303 for verification. The blurbs may be work history information (dates of employment, positions held, etc.), education (school attended, years, degree, etc.), certifications or publications, and more. Supporters at the relevant institutions (company, school, etc.) with appropriate email addresses are sent the blurbs for verification. After verification, the user can refer prospective employers to a unique URL where the user's verified resume is displayed. The hring manager or other representative of an employer 309 registers for the resume verification website 311 and searches for employees or investigates a prospective employee, bringing up their verified resumes at their unique URLs.

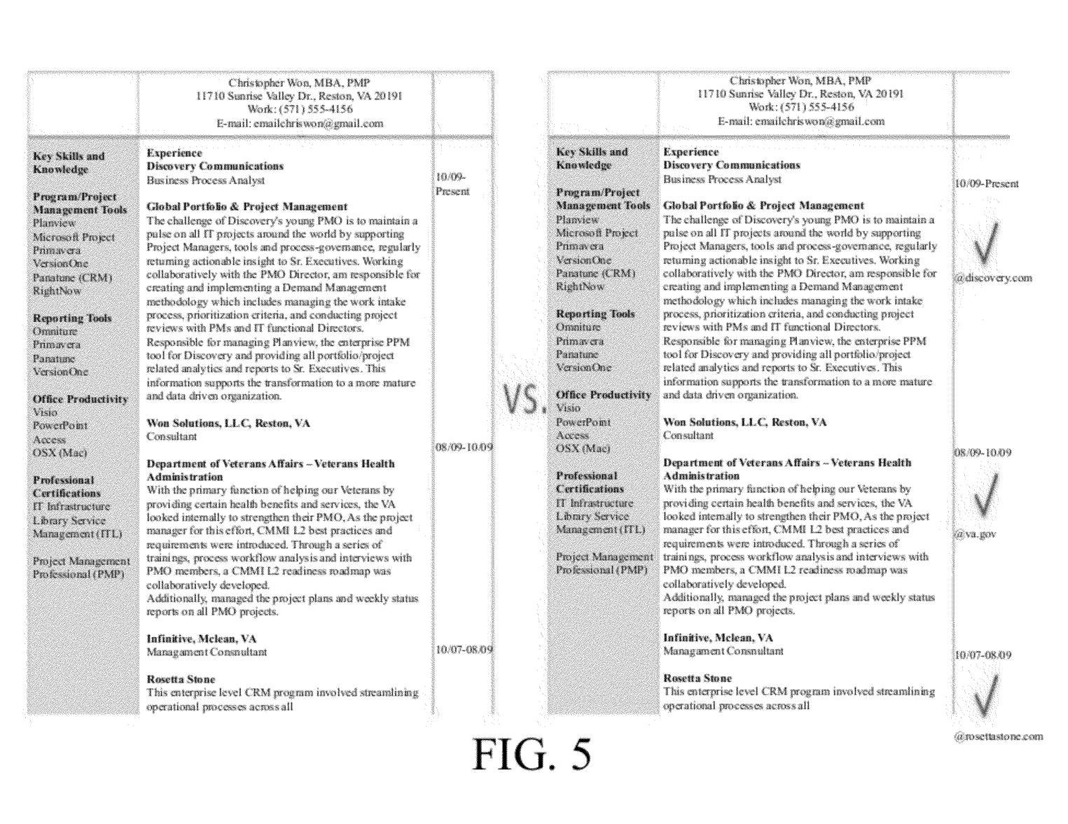

FIG. 5 compares an ordinary resume 401 with a verified resume 403. Both contain various information 405 such as work history information. However, the verified resume 407 indicates which information has been verified and how the information was verified. In the instance shown, the domain from which verification was received is provided.

The invention is not limited to the particular embodiments illustrated in the drawings and described above in detail. Those skilled in the art will recognize that other arrangements could be devised, for example, using downloadable software instead of a website interface, providing various user interfaces, verifying various types of information, etc. The invention encompasses every possible combination of the various features of each embodiment disclosed. While the invention has been described with reference to specific illustrative embodiments, modifications and variations of the invention may be constructed without departing from the scope of the invention.

I claim:

1. A processor-based system, comprising:
a data input software module configured to electronically enable a user to input data pertaining to an organization and an email address for an individual at the organization and configured to receive that input data,
a verification software module comprising a domain verification software module and a data verification software module,
wherein the domain verification software module is configured to verify that the email address submitted belongs to an individual associated with the organization by matching the domain in the email address to the organization's website domain or to verify that the email address submitted is not for a free web-based email service,
wherein the data verification software module is configured to transmit the data pertaining to the organization to the individual, enable the individual to confirm or deny the data, and receive the individual's confirmation or denial, and
a notification software module configured to transmit the individual's confirmation or denial to the user.

2. The system of claim 1, further comprising a transmittal software module configured to transmit the data pertaining to the organization along with information regarding the confirmation or denial of the data.

3. The system of claim 1, wherein the data pertaining to the organization comprises information about the user's employment history at the organization.

4. The system of claim 3, wherein the data input software module is configured to enable a user to create a resume by inputting resume information.

5. The system of claim 1, further comprising a database system configured to store the data pertaining to the organization.

6. The system of claim 4, further comprising a database system configured to store created resumes and a resume editing software module configured to allow a user to view and edit the inputted resume information.

7. The system of claim 6, further comprising an employer access software module configured to enable employers to search and display resumes stored in the database system.

8. The system of claim 7, further comprising a subscription software module configured to store employer payment information and process subscription payments.

9. The system of claim 2, wherein the data verification software module is configured to perform an additional verification step and the notification system is configured to transmit the results of the additional verification step to the user.

10. The system of claim 9, wherein the transmittal software module is configured to transmit information regarding the results of the additional verification step.

11. The system of claim 2, wherein the information regarding the confirmation or denial of the data comprises an explanation of how the data was verified or an indication of how rigorously the data was verified.

12. A method, comprising:
displaying via a processor a user interface into which a user can input data,
receiving via the processor user input pertaining to an organization and an email address for an individual at the organization,
verifying via the processor that the email address submitted belongs to an individual associated with the organization by matching the domain in the email address to the organization's website domain,
transmitting the input pertaining to the organization via the processor to the individual,
enabling the individual to confirm or deny the input,
receiving via the processor the individual's confirmation or denial, and
notifying the user via the processor of the individual's confirmation or denial.

13. The method of claim 12, wherein the input comprises information about the user's employment history at the organization.

14. The method of claim 12, further comprising receiving and storing resume information from the user and creating a resume.

15. The method of claim 14, further comprising allowing the user to edit the resume.

16. The method of claim 14, further comprising allowing employers to find and display the resume.

17. The method of claim 12, further comprising transmitting an explanation of how the input was verified or an indication of how rigorously the input was verified.

18. The method of claim 12, further comprising independently verifying the input pertaining to the organization.

19. The method of claim 18, further comprising transmitting to the user or to an employer the results of the independent verification.

20. In a processor-based system having a graphical user interface (GUI) including a display and an input device, a method of obtaining information on the display, verifying said information, and making said information available to employers, the method comprising:
entering via the input device work history information pertaining to an organization and an email address for an individual at the organization,
receiving from a server coupled to the GUI notification of the individual's confirmation or denial of the work history information pertaining to the organization, and
indicating via the input device that the work history information should be made available to employers.
